(19) United States
(12) Patent Application Publication
(10) Pub. No.: US 2011/0037905 A1
(43) Pub. Date: Feb. 17, 2011

(54) IMAGE REPRODUCING APPARATUS AND METHOD FOR CONTROLLING THE SAME

(75) Inventors: Hyun-seok CHOI, Seoul (KR); Sun-woo KIM, Suwon-si (KR); Sang-min BAE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/697,675

(22) Filed: Feb. 1, 2010

(30) Foreign Application Priority Data
Aug. 14, 2009 (KR) 10-2009-0075339

(51) Int. Cl. H04N 5/63

(52) U.S. Cl. 348/730; 348/E05.127

(57) ABSTRACT

Provided is a method of controlling an image reproducing apparatus. The method includes: determining whether a rebooting condition is satisfied, when an operation end signal is received; and selectively performing a rebooting operation based on a result of the determining.

### CROSS-REFERENCE TO RELATED PATENT APPLICATION

This application claims the priority from Korean Patent Application No. 10-2009-0075339, filed Aug. 14, 2009, in the Korean Intellectual Property Office, the disclosure of which is incorporated herein in its entirety by reference.

### BACKGROUND

1. Field

Apparatuses and methods consistent with the inventive concept relate to an image reproduction, and more particularly, to a broadcast reproducing apparatus and a method of controlling rebooting of the broadcast reproducing apparatus.

2. Description of the Related Art

With the development of information and communication technology, there is an increased demand for large capacity and high quality image data. In particular, in the field of image output devices such as televisions (TVs), digital TVs (DTVs) are promptly replacing analog TVs.

A DTV receives large capacity data to provide high image quality digital broadcasting. However, to provide digital broadcasting, the amount of broadcasting data to be processed is great and processing thereof is complicated. Thus, time required for booting the DTV may be substantially longer than for analog TVs.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to one or more exemplary embodiments, there is provided an image reproducing apparatus and a method of controlling the image reproducing apparatus, and more particularly, a broadcast reproducing apparatus and a method of controlling rebooting of the broadcast reproducing apparatus.

According to an aspect of an exemplary embodiment, there is provided a method of controlling an image reproducing apparatus, the method including: determining whether a rebooting condition is satisfied, when an operation end signal is received; and selectively performing a rebooting operation based on a result of the determining.

The selectively performing of the rebooting operation may include performing the rebooting operation if it is determined that the rebooting condition is satisfied, and controlling that the image reproducing apparatus operates in a sleep mode without the rebooting operation if it is determined that the rebooting condition is not satisfied.

When the rebooting operation is completed, the image reproducing apparatus is controlled to operate in a sleep mode.

The determining may include determining whether a period of time the image reproducing apparatus operates in a normal mode without rebooting is greater than or equal to a time.

The determining may include determining whether a frequency with which the image reproducing apparatus enters a sleep mode without rebooting is greater than or equal to a frequency value.

In the sleep mode, a power supply to modules, except for a control module which is to perform a resuming operation and a non-volatile memory where data is stored, may be blocked.

The selectively performing of the rebooting operation may include selectively performing a rebooting operation according to an internal booting mode in which data is not output to the outside.

The performing of the rebooting operation according to the first booting mode may include: re-driving an operational system of the image reproducing apparatus; and reloading an application into a memory of the image reproducing apparatus.

The image reproducing apparatus may include a DTV.

According to aspect of another exemplary embodiment, there is provided an image reproducing apparatus including: a rebooting unit performing a rebooting operation of the image reproducing apparatus; and a control unit determining whether a rebooting condition is satisfied upon receiving an operation end signal, and controlling the rebooting unit such that the rebooting operation is selectively performed according to a result of a determination.

### BRIEF DESCRIPTION OF THE DRAWINGS

The above and other aspects will become more apparent by describing certain exemplary embodiments with reference to the accompanying drawings, in which:

FIG. 1 is a block diagram illustrating an image reproducing apparatus according to an exemplary embodiment;

FIG. 2 illustrates a conversion of an operational mode of an image reproducing apparatus according to an exemplary embodiment;

FIG. 3 illustrates an operation of a control unit according to time according to an exemplary embodiment;

FIG. 4 illustrates a state of an internal module of an image reproducing apparatus according to operational states thereof; and

FIG. 5 is a flowchart illustrating a method of controlling an image reproducing apparatus according to an exemplary embodiment.

### DETAILED DESCRIPTION

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

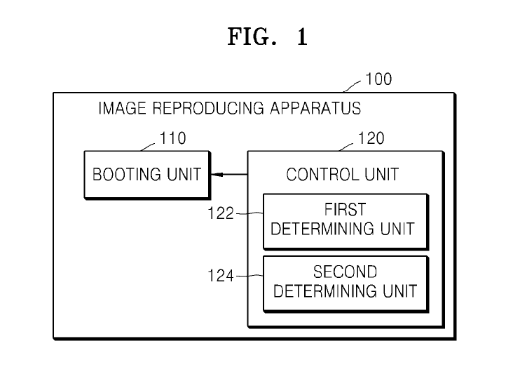

FIG. 1 is a block diagram illustrating an image reproducing apparatus 100 according to an exemplary embodiment. The image reproducing apparatus 100 may be any image reproducing apparatus including a display unit on which an image is output. For example, the image reproducing apparatus 100 may be a DTV.

The image reproducing apparatus 100 includes a booting unit 110 and a control unit 120.

According to the current exemplary embodiment, a mode of booting includes a normal booting mode and an internal booting mode. A normal booting mode refers to a booting mode in which normal booting operations are performed, and an internal booting mode refers to a booting mode in which only some of the normal booting operations of the normal booting mode are performed. In particular, in the booting operations according to the internal booting mode, operations related to outputting of processed data may not be performed. That is, during the booting operations according to the internal booting mode, although a module included in the image reproducing apparatus 100 processes data, the processed data is not output to the outside via an output module such as a display unit or a speaker. Since the processed data is not output to the outside during the booting operations according to the internal booting mode, the user may not be aware that the booting is in progress.

For convenience of description, it is assumed that a booting operation according to the normal booting mode includes driving an operating system (OS), loading necessary applications in a memory, tuning a channel which is to be watched by a user or a channel that is last watched by the user, decoding data transmitted through the tuned channel, and outputting the decoded data via a display unit. However, the normal booting mode does not necessarily consist of the above five operations but may include fewer or more operations than five above-mentioned operations.

For example, the internal booting mode may include only driving an OS and loading necessary applications in the memory of the above-described operations of the normal booting mode. However, alternatively, all of the operations of the normal booting mode, except for the displaying, may be performed during the internal booting mode.

Also, according to the current exemplary embodiment, an operational mode may include an end mode, a sleep mode, and a normal mode.

In the end mode, external power is not supplied to the image reproducing apparatus 100, or even when the external power is supplied, all or most modules of the image reproducing apparatus 100 do not operate. For example, only an interface module that receives a signal from a remote controller may operate in the end mode.

In the sleep mode, some hardware drivers or modules of the image reproducing apparatus 100 do not operate and/or the image reproducing apparatus 100 is maintained at a minimum consumption power. For example, power may be supplied only to a memory unit and an interface unit that receives a remote controller signal and the power to other modules may be blocked. In the sleep mode, data is not output to the outside but when a driving start signal is transmitted from the user, the sleep mode may be quickly converted into a normal mode by a resuming operation.

In the normal mode, most or all of the modules of the image reproducing apparatus 100 operate. In the normal mode, the image reproducing apparatus 100 may normally output data to the outside.

The booting unit 110 performs a rebooting operation of the image reproducing apparatus 100. The booting unit 110 is assumed to perform a rebooting operation of the image reproducing apparatus 100 according to the internal booting mode, in which data is not output to the outside, based on a predetermined rebooting condition.

Upon receiving an operation end signal, the control unit 120 determines whether a rebooting condition is satisfied. The control unit 120 may determine whether the rebooting condition is satisfied based on a state of the image reproducing apparatus 100 or an external condition.

The operation end signal is a signal that is generated when the user presses a ‘power off’ button or an ‘end’ button via an interface such as a remote controller. That is, the operation end signal is generated when the user indicates an end of the operation of the image reproducing apparatus 100. Similarly, an operation start signal is a signal that is generated when the user presses a ‘power on’ button or a ‘start’ button via an interface such as a remote controller.

The control unit 120 may set up the rebooting condition in various ways according to exemplary embodiments.

For example, if a time the image reproducing apparatus 100 operates in the normal mode without rebooting is longer than a predetermined time, the rebooting operation may be performed. In detail, a first determining unit 122 included in the control unit 120 determines whether a time period in which the image producing apparatus 100 operates in the normal mode without rebooting is longer than a predetermined time.

According to the current exemplary embodiment, when an operation end signal is transmitted by the user while the external power is being supplied to the image reproducing apparatus 100, the image reproducing apparatus 100 starts operating in the sleep mode. Also, if an operation start signal is transmitted by the user while the image reproducing apparatus 100 operates in the sleep mode, the image reproducing apparatus 100 starts operating in the normal mode again. That is, even when an operation end signal and an operation start signal are transmitted from the user, rebooting is not performed. Accordingly, data stored in a non-volatile memory unit is not erased but retained. The non-volatile memory unit may include a double data rate (DDR) memory unit. If the image reproducing apparatus 100 is not rebooted and the time the image reproducing apparatus 100 operates in the normal mode gets longer, data is not stored regularly aligned in the memory unit. In this case, an operational speed of the image reproducing apparatus 100 may become slow or errors may be generated in executing an OS or an application. To solve this problem, the operation may be controlled such that a rebooting operation is performed if the time the image reproducing apparatus 100 operates in the normal mode is a predetermined time or longer.

According to another exemplary embodiment, the operation may be controlled such that a rebooting operation is performed if a frequency with which the image reproducing apparatus 100 enters the sleep mode is greater than or equal to a predetermined frequency value. In detail, a second determining unit 124 included in the control unit 120 determines whether a frequency with which the image reproducing apparatus 100 enters the sleep mode or the normal mode without rebooting is greater than or equal to a predetermined frequency value. If the frequency with which the image reproducing apparatus 100 enters the sleep mode is great, it means that the image reproducing apparatus 100 frequently operates in the normal mode without rebooting. In this case, problems as described above may be generated. In order to solve this problem, if the frequency with which the image reproducing apparatus 100 enters the sleep mode is greater than or equal to a predetermined frequency value, a rebooting operation may be performed.

Alternatively, after external power is supplied to the image reproducing apparatus 100, a rebooting operation may be performed periodically when a predetermined time period expires or when a temperature of a module reaches a predetermined value or greater or when a voltage or current applied to the module is a predetermined value or greater.

The control unit 120 controls the booting unit 110 to selectively perform a rebooting operation based on determination of the first determining unit 122 or the second determining unit 124. In detail, the control unit 120 may control the booting unit 110 to perform a rebooting operation if a rebooting condition is satisfied. The control unit 120 controls the image reproducing apparatus 100 to operate in the sleep mode if a rebooting operation is ended or if the rebooting condition is not satisfied.

In the sleep mode, a power supply to other modules, except for a control module for performing a resuming operation, a non-volatile memory where data is accumulated, and an interface unit, may be blocked. The module for performing a resuming operation may be a central processing unit (CPU) included in the image reproducing apparatus 100, but may also be the control unit 120. Also, according to exemplary embodiments, the control unit 120 and a CPU may be realized as a single module. According to an exemplary embodiment, it is assumed for convenience of description that the control unit 120 performs a resuming operation.

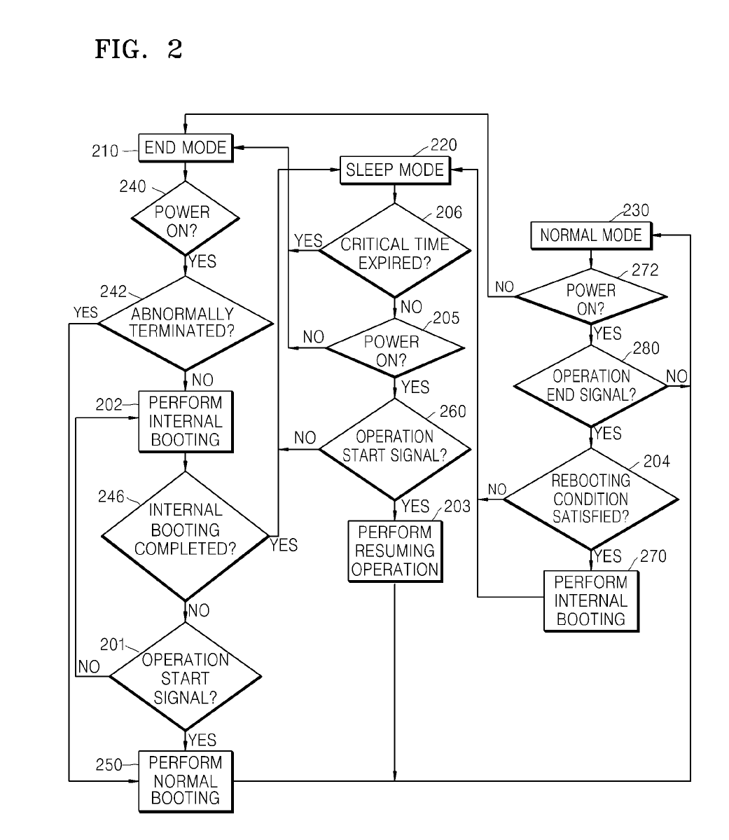

FIG. 2 illustrates a conversion of an operational mode of an image reproducing apparatus 100 according to an exemplary embodiment.

When the external power is supplied to the image reproducing apparatus 100 in an end mode 210 (operation 240), it is checked whether the previous normal mode operation was abnormally terminated (operation 242). If the previous normal mode operation was not abnormally terminated, a booting unit 110 boots the image reproducing apparatus 100 according to an internal booting mode (operation 202). If an operation start signal is transmitted from the user (operation 201) before the booting according to the internal booting mode is completed (operation 246), the booting unit 110 boots the image reproducing apparatus 100 according to a normal booting mode after the booting operation that has been currently conducted (operation 250). When the booting operation according to the normal booting mode is completed, the image reproducing apparatus 100 starts operating in a normal mode 230.

If an operation start signal is not transmitted from the user until booting according to the internal booting mode is completed, the image reproducing apparatus 100 starts operating in a sleep mode 220.

When an external power supply to the image reproducing apparatus 100 is blocked in the sleep mode 220 (operation 205), the operational mode of the image reproducing apparatus 100 is converted into the end mode 210. Also, when the image reproducing apparatus 100 operates in the sleep mode 220 longer than a time period of a predetermined value (operation 206), the operational mode of the image reproducing apparatus 100 may be converted into the end mode 210.

In operation 260, it is checked whether an operation start signal is transmitted from the user in the sleep mode 220. If the operation start signal is transmitted, the control unit 120 performs a resuming operation (operation 203) and the image reproducing apparatus starts operating in the normal mode 230 when the resuming operation is completed.

In the normal mode 230, when the external power supply to the image reproducing apparatus 100 is blocked (operation 272), the operational mode of the image reproducing apparatus 100 may be converted into the end mode 210. In this case, the control unit 120 recognizes the external power supply being blocked as an abnormal end of operations and controls the image reproducing apparatus 100 to operate in the normal mode 230 if the external power is supplied again even when an operational start signal is not transmitted from the user (operations 240, 242, 250).

When an operation end signal is received from the user in the normal mode 230 (operation 280), the control unit 120 determines whether a rebooting condition is satisfied (operation 204). If the rebooting condition is satisfied, the booting unit 110 reboots the image reproducing apparatus 100 in the internal booting mode (operation 270). Also, the control unit 120 controls the image reproducing apparatus 100 to start operating in the sleep mode 220 when the rebooting operation is completed or if the rebooting condition is not satisfied.

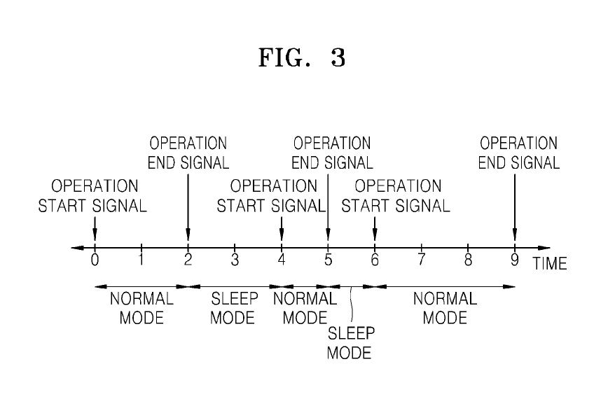

FIG. 3 illustrates an operation of a control unit 120 according to time, according to an exemplary embodiment.

In the present exemplary embodiment, it is assumed that a rebooting operation is performed when the image reproducing apparatus 100 operates in a normal mode for four hours or more without rebooting.

In FIG. 3, a horizontal axis refers to time in units of one hour.

It is assumed that the external power is supplied for the first time at a time ‘0’. When the external power is supplied, a booting operation is performed according to an internal booting mode. If an operation start signal is received before the booting operation according to the internal booting mode is completed, a booting operation according to a normal booting mode is performed after the previous booting operation. On the other hand, if an operation start signal is not received until the booting operation according to the internal booting mode is ended, the image reproducing apparatus 100 operates in the sleep mode.

When the booting operation according to the normal booting mode is completed, the image reproducing apparatus 100 operates in the normal mode. Also when an operation start signal is received while the image reproducing apparatus 100 operates in the sleep mode, the image reproducing apparatus 100 operates in the normal mode after a resuming operation is performed.

Referring to FIG. 3, the image reproducing apparatus 100 operates for two hours in the normal mode after the external power is supplied. If the image reproducing apparatus 100 operates in the normal mode for five hours without rebooting, the rebooting condition is set such that rebooting is performed.

An operation end signal is received two hours after the external power is first supplied. When an operation end signal is received, the control unit 120 determines whether a rebooting condition is satisfied. Since the image reproducing apparatus 100 has operated in the normal mode without rebooting for two hours, the rebooting condition is not satisfied. Accordingly, the control unit 120 controls the booting unit 110 not to perform a rebooting operation, and controls the image reproducing apparatus 100 to operate in the sleep mode without rebooting.

An operation start signal is received four hours after the external power is first supplied. The control unit 120 performs a resuming operation when the resuming operation is ended, the image reproducing apparatus 100 starts operating in the normal mode.

An operation end signal is received five hours after the external power is first supplied. Since the image reproducing apparatus 100 has operated in the normal mode without rebooting for three hours, the rebooting condition is not satisfied. Accordingly, the control unit 120 controls the booting unit 110 not to perform a rebooting operation and the image reproducing apparatus 100 to start operating in the sleep mode without rebooting.

An operation start signal is received six hours after the external power is first supplied. The control unit 120 performs a resuming operation when the resuming operation is ended, the image reproducing apparatus 100 starts operating in the normal mode.

An operation end signal is received nine hours after the external power is first supplied. Since the image reproducing apparatus 100 has operated in the normal mode without rebooting for six hours, a rebooting condition is satisfied. Accordingly, the control unit 120 controls the booting unit 110 to perform a rebooting operation. The booting unit 110 performs a rebooting operation according to an internal booting mode. When the rebooting operation is completed, the control unit 120 controls the image reproducing apparatus 100 to operate in the sleep mode.

In another exemplary embodiment, it is assumed that a rebooting operation is performed if the image reproducing apparatus 100 enters a sleep mode at least twice without rebooting.

An operation end signal is first received two hours after the external power is first supplied. Since a rebooting condition is set such that rebooting is performed when the image reproducing apparatus 100 enters the sleep mode at least twice without rebooting, the rebooting condition is not satisfied. Accordingly, the control unit 120 controls the booting unit 110 not to perform a rebooting operation and the image reproducing apparatus 100 starts operating in the sleep mode without rebooting.

An operation end signal is received again five hours after the external power is first supplied. Here, the image reproducing apparatus 100 enters the sleep mode without rebooting for a second time, and thus the rebooting condition is satisfied. Accordingly, the control unit 120 controls the booting unit 110 to perform a rebooting operation. The booting unit 110 performs a rebooting operation according to an internal booting mode. When the rebooting operation is ended, the control unit 120 controls the image reproducing apparatus 100 to operate in the sleep mode.

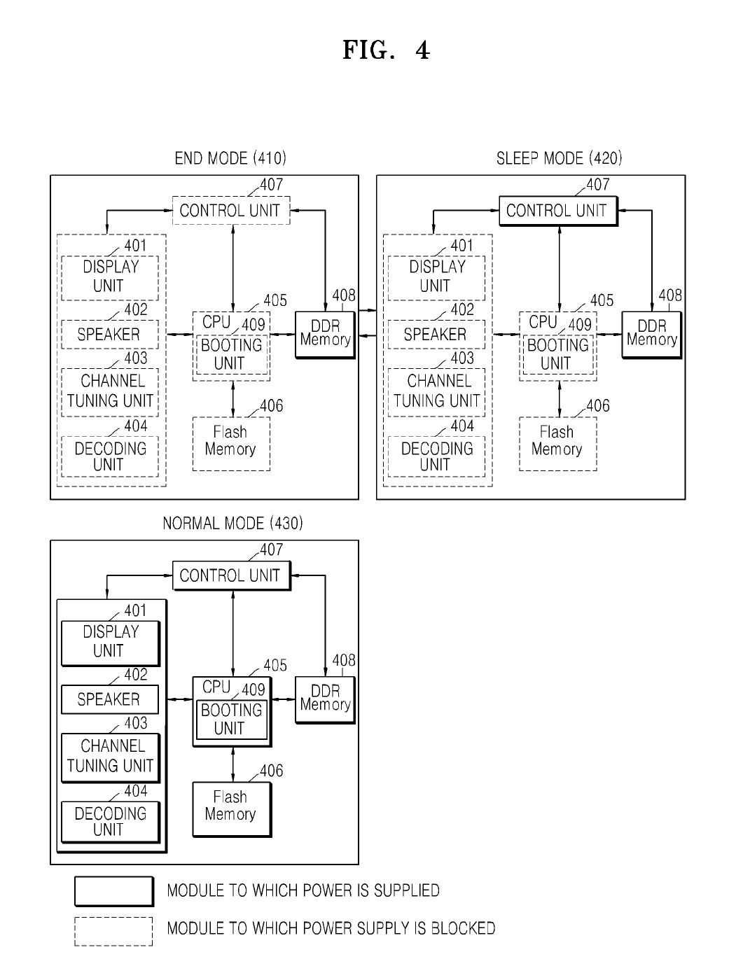

FIG. 4 illustrates a state of an internal module of an image reproducing apparatus 400 according to operational states thereof. For convenience of description, the image reproducing apparatus 400 is assumed to include a display unit 401, a speaker 402, a channel tuning unit 403, a decoding unit 404, a CPU 405, a flash memory unit 406, a control unit 407, and a DDR memory unit 408. However, the elements of the image reproducing apparatus 400 are not limited thereto. At least one module may be either included or omitted. Also, in the current exemplary embodiment, a booting unit 409 is included in the CPU 405 but may also be separated from the CPU 405 or combined with the control unit 407.

In FIG. 4, modules illustrated with a solid line denote modules to which power is supplied, and modules illustrated with a dotted line denote modules to which power is not supplied.

In an end mode 410, power is not supplied to all modules.

When external power is supplied in the end mode 410, a booting operation is performed according to an internal booting mode. In the current exemplary embodiment, power is supplied to the modules related to the booting operation according to the internal booting mode. Referring to FIG. 4, power may be supplied to the CPU 405, the flash memory unit 406, and the DDR memory unit 408.

If an operation start signal is not received until the booting operation according to the internal booting mode is completed, the image reproducing apparatus 100 operates in a sleep mode 420. In the sleep mode 420, power is supplied only to the control unit 407 and the DDR memory unit 408. When the booting operation according to the internal booting mode is ended, a boot image is stored in the DDR memory unit 408. Power is continuously supplied to the DDR memory unit 408 so that the boot image is not deleted but retained.

When an operation start signal is received in the sleep mode 420, the image reproducing apparatus 100 operates in a normal mode 430. In the normal mode 430, power is supplied to all modules.

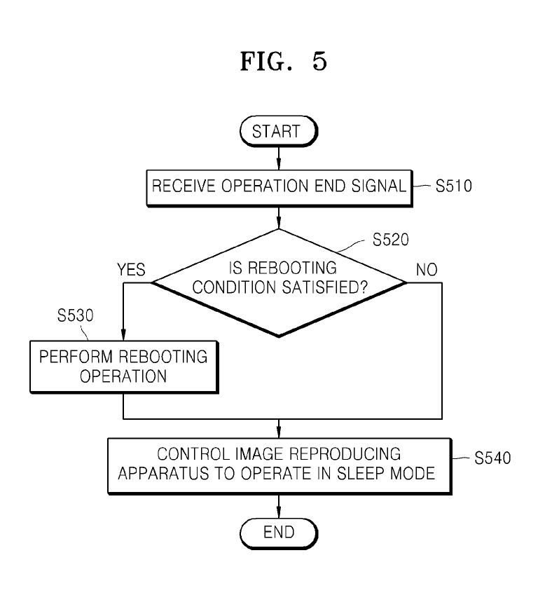

FIG. 5 is a flowchart illustrating a method of controlling an image reproducing apparatus according to an exemplary embodiment.

In operation S510, an operation end signal is received.

In operation S520, whether a rebooting condition is satisfied is determined. When it is determined that the rebooting condition is satisfied, the method proceeds to operation S530, and if it is determined that the rebooting condition is not satisfied, the method proceeds to operation S540.

In operation S530, a rebooting operation is selectively performed according to an internal booting mode in which data is not output to the outside.

In operation S540, the image reproducing apparatus is controlled to operate in a sleep mode.

Exemplary embodiments can be implemented with the computer programs and can be implemented in general-use computers that execute the programs using a computer-readable recording medium.

Examples of the computer-readable recording medium include magnetic storage media (e.g., ROM, floppy disks, hard disks, etc.), and optical recording media (e.g., CD-ROMs, or DVDs).

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling an image reproducing apparatus, the method comprising:
determining whether a rebooting condition is satisfied, when an operation end signal is received; and
selectively performing a rebooting operation based on a result of the determining.

2. The method of claim 1, wherein the selectively performing the rebooting operation comprises performing the rebooting operation if it is determined that the rebooting condition is satisfied, and controlling the image reproducing apparatus to operate in a sleep mode without performing the rebooting operation if it is determined that the rebooting condition is not satisfied.

3. The method of claim 2, further comprising controlling the image reproducing apparatus to operate in the sleep mode when the rebooting operation is completed.

4. The method of claim 1, wherein the determining comprises determining whether a period of time the image reproducing apparatus operates in a normal mode without rebooting is greater than or equal to a time value.

5. The method of claim 1, wherein the determining comprises determining whether a frequency with which the image reproducing apparatus enters a sleep mode without rebooting is greater than or equal to a frequency value.

6. The method of claim 2, wherein in the sleep mode, a power supply to modules, except for a control module which is to perform a resuming operation and a non-volatile memory where data is stored, is blocked.

7. The method of claim 1, wherein the selectively performing the rebooting operation comprises performing the rebooting operation according to an internal booting mode in which data is not output to the outside.

8. The method of claim 7, wherein the performing the rebooting operation according to the internal booting mode comprises:
re-driving an operating system of the image reproducing apparatus; and
reloading an application into a memory of the image reproducing apparatus.

9. The method of claim 1, wherein the image reproducing apparatus comprises a digital television.

10. An image reproducing apparatus comprising:
a rebooting unit which performs a rebooting operation of the image reproducing apparatus; and
a control unit which determines whether a rebooting condition is satisfied upon receiving an operation end signal, and controls the rebooting unit such that the rebooting operation is selectively performed according to a result of a determination.

11. The image reproducing apparatus of claim 10, wherein the control unit controls to perform the rebooting operation if it is determined that the rebooting condition is satisfied, and controls the image reproducing apparatus to operate in a sleep mode without performing the rebooting operation if it is determined that the rebooting condition is not satisfied.

12. The image reproducing apparatus of claim 11, wherein the control unit controls the image reproducing apparatus to operate in the sleep mode when the rebooting operation is completed.

13. The image reproducing apparatus of claim 10, wherein the control unit comprises a first determining unit that determines whether a time period during which the image reproducing apparatus operates in a normal mode without rebooting is greater than or equal to a time value.

14. The image reproducing apparatus of claim 13, wherein the control unit comprises a second determining unit that determines whether a frequency with which the image reproducing apparatus operates in a normal mode without rebooting is greater than or equal to a frequency value.

15. The image reproducing apparatus of claim 12, wherein in the sleep mode, a power supply to modules, except for a control module for performing a resuming operation and a non-volatile memory where data is stored, is blocked.

16. The image reproducing apparatus of claim 10, wherein the rebooting unit performs the rebooting operation according to an internal booting mode in which data is not output to the outside.

17. The image reproducing apparatus of claim 16, wherein the rebooting unit comprises:
an operating system driving unit which re-drives an operating system of the image reproducing apparatus; and
a reloading unit which reloads an application into a memory of the image reproducing apparatus.

18. The image reproducing apparatus of claim 10, wherein the image reproducing apparatus comprises a digital television.

19. A computer-readable recording medium storing a program which, when executed by a computer, causes the computer to execute the method of claim 1.

20. A method comprising:
receiving an operation end signal which identifies a command to terminate a normal mode operation of an image reproducing apparatus;
verifying a rebooting condition which specifies whether a rebooting operation is to be performed; and
one of performing the rebooting operation and entering a sleep mode operation and entering a sleep mode operation, based on a result of the verifying.

21. The method of claim 20, wherein the verifying comprises:
determining a time period during which the image reproducing apparatus operates in a normal mode operation without rebooting; and
comparing the determined time period to a predetermined time value.

22. The method of claim 21, wherein the method further comprises:
performing the rebooting operation if the determined time period is greater than or equal to the predetermined time value; and
entering the sleep mode operation upon completion of the rebooting operation.

23. The method of claim 20, wherein the rebooting condition specifies at least one of a time period during which the image reproducing apparatus operates without rebooting and a number of times the image reproducing apparatus enters the sleep mode without rebooting.
